(19) United States
(12) Patent Application Publication
(10) Pub. No.: US 2008/0151134 A1
(43) Pub. Date: Jun. 26, 2008

(54) Solar flashing device

(76) Inventor: Chin-Lin Huang, Taipei County (TW)

Correspondence Address: BACON & THOMAS, PLLC, 625 SLATERS LANE, FOURTH FLOOR, ALEXANDRIA, VA, 22314, US

(21) Appl. No.: 11/642,640

(22) Filed: Dec. 21, 2006

(51) Int. Cl. G02F 1/135

(52) U.S. Cl. 349/25

(57) ABSTRACT

An solar flashing device that can generate an effect of flashing by using a TN typed LCD panel, and using the solar energy as a electric power source; it is applicable to a decorative pendant for a key ring, a tab for baggage or a name plate, or is suitable for embedding in a personal appliance or ornament, its range of application is very wide. In its structure, it is provided in a housing having a light penetrable top surface with: a TN typed LCD panel beneath the light penetrable top surface, a changeable marking sheet beneath the LCD panel, a solar energy panel and an electric circuit board, by control of the electric circuit board, liquid crystal molecules in the LCD panel can intermittently obscure light and allow light penetrating, and when being light penetrable, letters or a pattern on a marking sheet can appear to generate the effect of flashing.

### BACKGROUND OF THE INVENTION

1. Field of the Invention

The present invention relates to a solar flashing device, and especially to a device that gives a flashing effect by using an LCD panel and by taking the solar energy as a electric power source to drive the LCD panel; the solar flashing device is applicable to a decorative pendant for a key ring, a tab for baggage or a name plate, or is suitable for embedding in a personal appliance or ornament such as a picture frame, a cell phone seat or a receiving box on a desk etc., its range of application is very wide.

2. Description of the Prior Art

In our daily life, marker tablets are widely used for personal articles and ornaments, e.g.: marker tablets having thereon names are used to make decorative pendants for key rings, tabs for baggage or name plates etc. The functions of the marker tablets include, in addition to identification, advertising; many enterprises even make marker tablets with the trade marks of their companies and have the tablets embedded in various gifts or presents in order that the gifts or presents, such as a picture frame, a cell phone seat, a pen container or a receiving box on a desk etc., can have the function of advertising.

The above marker tablets can have both the functions of identification and advertising; if they have a flashing effect, they will be more attractive for people's viewing; this makes their functions of identification and advertising even further be enhanced. Therefore, there is a kind of marker tablet provided with an LED in the prior art, such a marker tablet takes advantage of intermittent lighting of the LED to illuminate a tablet marked with letters or a picture, so that the marker tablet can flash to attract people's viewing.

Having the effect of attracting people's viewing by taking advantage of intermittent lighting of the LED may dazzle people's eyes in some places. For example, in some more quiet places such as a concert hall, a cinema etc., if one carries on his person a flashing decorative pendant for a key ring or a name plate, what he attracts will be abominating eye vision lines. Thereby, the present invention aims at designing a marker tablet that has the effect of flashing without dazzling, and this is the goal of the inventor of the present invention.

As is the case of the prior art, a TN (Twisted Nematic) typed LCD panel is a kind of device having the effect of flashing without dazzling. Its principle is to use a driving chip to drive liquid crystal molecules in a specific area in an LCD panel for twisting for 90 degrees, so that light beams are unable to penetrate the liquid crystal molecules in this area, and thus this area forms letters or a pattern of deep colors; when the driving chip stops driving the liquid crystal molecules, the liquid crystal molecules restore their original nematic phase that makes the LCD panel light penetrable; by intermittent light penetrable and non-light penetrable nature of the specific area on the LCD panel, the effect of flashing is obtained. For instance: for a clock using the LCD panel to display numbers, when a user makes correction for the time, the numbers are displayed intermittently by the LCD driving chip to generate the effect of flashing.

The above stated conventional LCD displaying mode can generate the effect of flashing, but when it is used on a marker tablet generally for personal purpose, there will be many problems to be solved. For example, a marker tablet must be able to display outstanding letters or pattern according to the requirement of a user, and an effect of identification can then be obtained. However, in this way, an LCD panel and its driving chip must be specifically designed for a person or a company, it not only is expensive, time and work consumptive, but also a manufacturer and a marketer are both unable to directly provide spot stocks of such for consumers, it evidently does not have an economic value in the whole supply and demand market.

### SUMMARY OF THE INVENTION

In view of the above stated, the inventor of the present invention studied and developed a device that can generate an effect of flashing by using a TN typed LCD panel, and using the solar energy as an electric power source; it is provided in a housing having a light penetrable top surface with: a TN typed LCD panel beneath the light penetrable top surface, a changeable marking sheet beneath the LCD panel, a solar energy panel and an electric circuit board, by control of an LCD driving chip on the electric circuit board, liquid crystal molecules in the LCD panel can intermittently obscure light and allow light penetrating, and when being light penetrable, letters or a pattern on the marking sheet can appear to thereby generate the effect of flashing.

The advantages of the present invention is resided in that: by the function of changing the marking sheet, a user can write letters or draw a pattern on the marking sheet by himself; when an enterprise desires to mark the letters or draw a device of a trademark on the marking sheet, it needs only to print for making other marking sheets to be placed in a related position, and the same object of displaying can be achieved too without any change of the LCD panel or the driving chip; the present invention can be applicable to a decorative pendant for a key ring, a tab for baggage or a name plate, or is suitable for embedding in a personal appliance or ornament such as a picture frame, a cell phone seat or a pen container etc., its range of application is very wide.

The present invention will be apparent in its technical measures after reading the detailed description of the preferred embodiment thereof in reference to the accompanying drawings.

### BRIEF DESCRIPTION OF THE DRAWINGS

FIG. 1 is an anatomic perspective view of the present invention;

FIG. 2 is a perspective view of the present invention after assembling;

FIG. 3 is a perspective schematic view showing an LCD panel of the present invention in the light penetrable state;

FIG. 4 is a perspective schematic view showing the LCD panel of the present invention in the light obscuring state;

FIG. 5 is a perspective schematic view showing the present invention is placed on a receiving box;

FIG. 6 is a perspective schematic view showing the present invention is used on a picture frame;

FIG. 7 is a perspective schematic view showing the present invention is used on a clip;

FIG. 8 is a perspective schematic view showing the present invention is used on a name plate.

### DETAILED DESCRIPTION OF THE PREFERRED EMBODIMENT

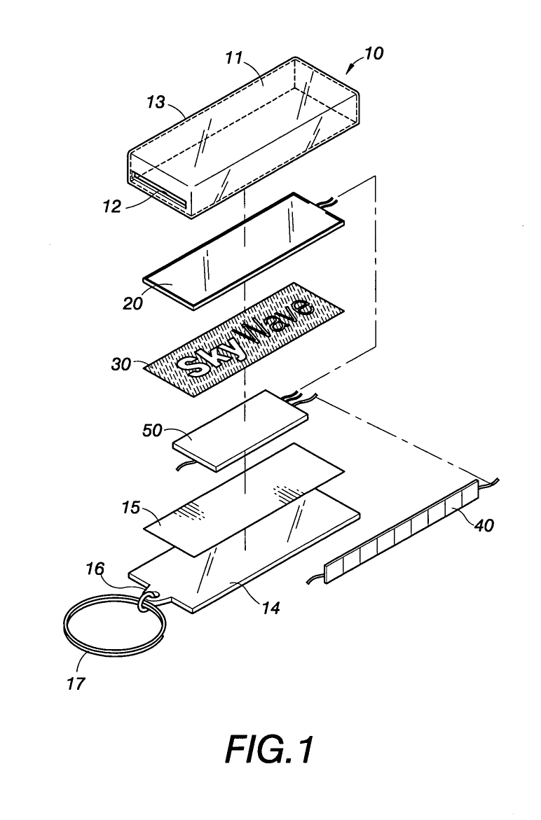

Referring firstly to FIG. 1, the solar flashing device of the present invention is provided in a housing 10 with: an LCD panel 20, a marking sheet 30, a solar energy panel 40 and an electric circuit board 50.

Wherein the housing 10 has therein a receiving space with a transparent top surface 11 on the top thereof and a lateral opening 12 on a lateral side thereof; in this embodiment, the housing 10 is closed with an upper lid 13 and a lower lid 14 both made of transparent material, the upper lid 13 forms the top surface 11, while the lower lid 14 is provided on the upper surface thereof with a light reflective plate 15 in order that light beams are unable to penetrate through the bottom of the housing 10.

The LCD panel 20 is fixed beneath the light penetrable top surface 11 of the housing 10, so that a person can see the LCD panel 20 through the light penetrable top surface 11 from outside. The LCD panel 20 is a TN typed LCD panel, it is light penetrable when liquid crystal molecules therein are not yet driven; and the liquid crystal molecules get a function of light obscuring to almost completely prevent the light from penetrating when the liquid crystal molecules are driven for twisting for 90 degrees, so that an area where the liquid crystal molecules act in the LCD panel 20 appears to be in deep colors near the black color.

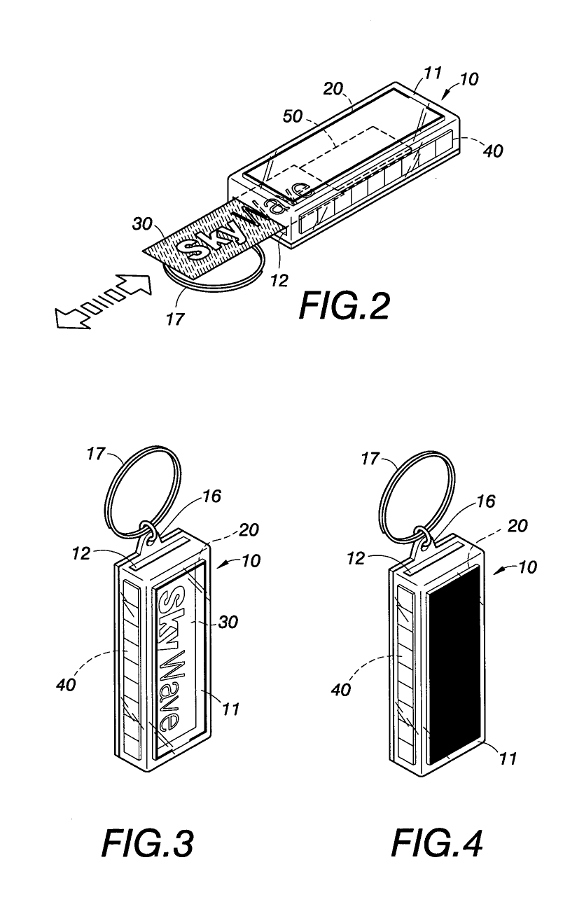

The marking sheet 30 is a thin sheet provided beneath the LCD panel 20, a top surface of it is printed or carved with letters or a pattern; the marking sheet 30 can be placed in from the lateral opening 12 of the housing 10 at a position beneath the LCD panel 20, and can be drawn out of the lateral opening 12; the marking sheet 30 can be changed in pursuance of the requirement of a user; and the situation that the marking sheet 30 is placed in or drawn out of the lateral opening 12 at the position beneath the LCD panel 20 is shown in the action schematic view disclosed in FIG. 2.

The solar energy panel 40 is a conventional member that can receive light from a light source to convert light into electric power, by virtue that the housing 10 in the embodiment is composed of the upper lid 13 and the lower lid 14 both made of transparent material, the solar energy panel 40 can be provided on a lateral side of the housing 10 when it is put in the housing 10. Surely if the housing 10 must be embedded in some article as being demanded in using, the solar energy panel 40 can also be provided at any position beneath the light penetrable top surface 11 to receive light from the light source.

The electric circuit board 50 is provided beneath the marking sheet 30 in observance of a principle of being not obscuring the marking sheet 30. The electric circuit board 50 is electrically connected with the solar energy panel 40 and the LCD panel 20, it has a power source electric circuit to receive the power generated by the solar energy panel 40, and has an LCD driving chip to intermittently drive the liquid crystal molecules of the LCD panel 20 for operation; this power source electric circuit and the LCD driving chip are conventional and are not narrated further.

Referring simultaneously to FIGS. 1, 3 and 4, with the structure stated above, when the solar energy panel 40 generates the power in receiving the solar energy, the electric circuit board 50 operates in an intermittent mode taking advantage of the electric power to drive the liquid crystal molecules of LCD panel 20 through the LCD driving chip.

Wherein: when the liquid crystal molecules of the LCD panel 20 stop operating, by the fact that the light penetrable top surface 11 of the housing 10 and the LCD panel 20 are both transparent, the vision line of a person can get through the light penetrable top surface 11 of the housing 10 and the LCD panel 20 to see the letters or the pattern on the marking sheet 30.

After the electric circuit board 50 drives the liquid crystal molecules of the LCD panel 20 for operation and twisting, the area where the liquid crystal molecules act get a function of light obscuring to almost completely prevent the light from penetrating, so that the area where the liquid crystal molecules act in the LCD panel 20 appears to be in deep colors near the black color, and the person can not have his vision line get through the LCD panel 20, nor can he see the marking sheet 30. In the embodiment as shown in FIG. 4, the area where the liquid crystal molecules act in the LCD panel 20 is a whole surface, so that the whole LCD panel 20 is in the black color, thus the marking sheet 30 is in an obscured state.

Therefore, by the intermittent appearing of the letters or the pattern, the flashing effect can be obtained that can get the effect of attracting people's viewing.

What are shown in FIGS. 1-4 represent an embodiment of the solar flashing device of the present invention used on a decorative pendant for a key ring; in disclosure of the drawings, in addition to the above disclosed structure, the housing 10 can be provided on a lateral side thereof with a hanging hole 16 for hanging a key ring 17 that can be used for hanging keys, thereby the entire device forms a decorative pendant for the key ring 17. And a tab for baggage is structurally similar to this, it needs only to provide on the hanging hole 16 with an accessory such as a tying rope or a hanging hook, a tab for baggage can thus be formed.

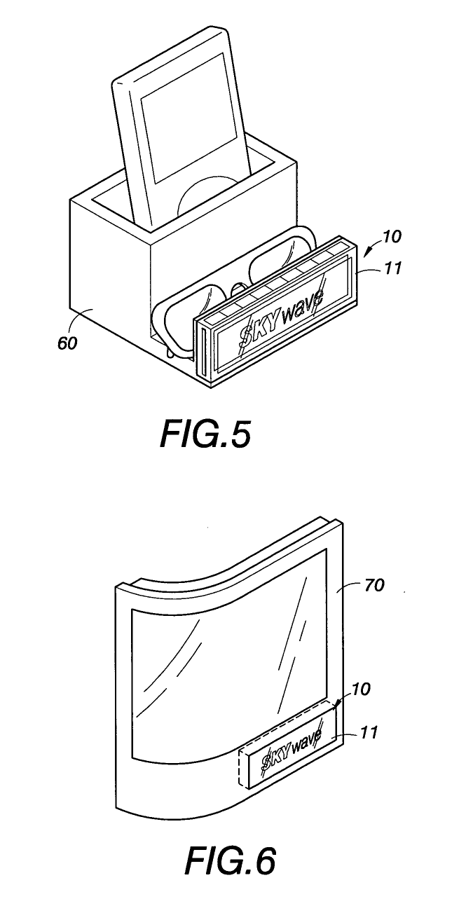

FIGS. 5-8 show application of the present invention to various articles; wherein FIG. 5 shows a small receiving box 60 often seen in a house or an office, the receiving box 60 can be used for putting therein a portable digital article such as a cell phone, an MP3 Player etc. or a pair of spectacles or stationery etc., it is often used as a gift by an enterprise; after assembling, the housing 10 of the present invention can be placed on the receiving box 60 to form a device having the effect of flashing; and the letters or the pattern in the device can have the function of advertising.

FIG. 6 shows a picture frame 70 often seen on a desk in a house or an office, after assembling, the housing 10 of the present invention can be put on the periphery of the picture frame 70, a user can write letters representing a date or description of a scene etc. to give meaning to the photo or picture in the picture frame 70.

FIG. 7 shows a clip 80 that can be used to clamp documents or some other article, similarly, after assembling, the housing 10 of the present invention can be put on a shank of the clip 80, by writing any group of various identification letters on the above stated marking sheet 30, a user can be aware clearly of lodgment of the important documents that are specifically marked on the marking sheet 30 among a great amount of documents.

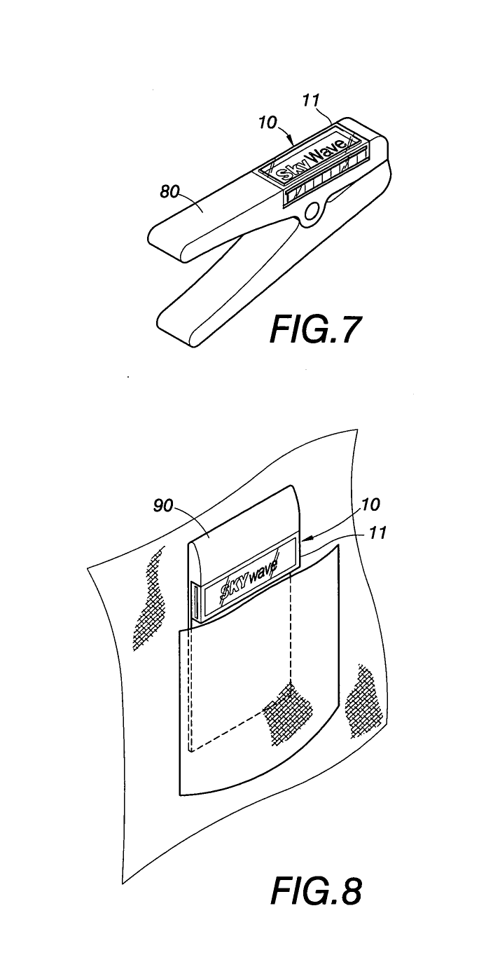

FIG. 8 is a perspective schematic view showing that an embodiment of the present invention is used on a name plate 90; the name plate 90 is often hung on a suit of clothes of a service staff of a restaurant or a hotel for identification.

The names of the members and the drawings for the present invention are only for illustrating preferred embodiments of the present invention, and not for giving any limitation to the scope of the present invention. It will be apparent to those skilled in this art that various equivalent modifications or changes without departing from the spirit, scope and characteristic of this invention shall fall within the scope of the appended claims.

1. An solar flashing device, being provided in a housing having a light penetrable top surface with: a TN typed LCD panel beneath said light penetrable top surface, a changeable marking sheet beneath said TN typed LCD panel, a solar energy panel adapted to receiving light from a light source and converting said light into electric power and an electric circuit board electrically connected with said solar energy panel, by control of an LCD driving chip on said electric circuit board, liquid crystal molecules in said LCD panel intermittently obscures light and allows light penetrating, and when being light penetrable, light penetrates said light penetrable top surface and said LCD panel, letters or a pattern on a marking sheet appear to generate an effect of flashing.

2. The solar flashing device as in claim 1, wherein: an area where said liquid crystal molecules act in said LCD panel is a whole surface.

3. The solar flashing device as in claim 1, wherein: said housing has a lateral opening on a lateral side thereof for changing said marking sheet.

4. The solar flashing device as in claim 1, wherein: said housing is closed with an upper lid and a lower lid both made of transparent material, said upper lid forms said light penetrable top surface.

5. The solar flashing device as in claim 4, wherein: said lower lid is provided on an upper surface thereof with a light reflective plate in order that light beams are unable to penetrate through a bottom of said housing.

6. The solar flashing device as in claim 1, wherein: said housing is provided on a lateral side thereof with a hanging hole for hanging a key ring, a tying rope or a hanging hook.

7. The solar flashing device as in claim 1, said solar flashing device is adapted for embedding in a personal appliance or ornament.
